(19) United States
(12) Patent Application Publication
(10) Pub. No.: US 2026/0149049 A1
(43) Pub. Date: May 28, 2026

(54) BATTERY

(71) Applicant: TOYOTA JIDOSHA KABUSHIKI KAISHA, Toyota-shi (JP)

(72) Inventor: Masaharu SENOUE, Seto-shi (JP)

(73) Assignee: TOYOTA JIDOSHA KABUSHIKI KAISHA, Toyota-shi (JP)

(21) Appl. No.: 19/379,545

(22) Filed: Nov. 4, 2025

(30) Foreign Application Priority Data
Nov. 22, 2024 (JP) 2024-204208

(51) Int. Cl. H01M 10/0569; H01M 4/02; H01M 4/13; H01M 10/0525; H01M 10/0585

(52) U.S. Cl. CPC H01M 10/0569; H01M 4/13; H01M 10/0525; H01M 10/0585; H01M 2004/029; H01M 2300/0034; H01M 2300/0042

(57) ABSTRACT

A battery includes a bipolar electrode that includes an intermediate current collector, a cathode composite layer disposed on a first surface of the intermediate current collector, and an anode composite layer disposed on a second surface of the intermediate current collector. The battery includes a plurality of cells arranged in a thickness direction. Each cell includes an electrode assembly that includes the cathode composite layer, a separator layer, and the anode composite layer. Each cell independently contains an electrolytic solution containing fluoroethylene carbonate (FEC) as a solvent component. When, among the cells, the cell located at an end in the thickness direction is defined as an end cell and the cell located inward of the end cell is defined as an internal cell, the proportion of FEC in the solvent component of the internal cell is greater than the proportion of FEC in the solvent component of the end cell.

### CROSS-REFERENCE TO RELATED APPLICATION

This application claims priority to Japanese Patent Application No. 2024-204208 filed on Nov. 22, 2024. The disclosure of the above-identified application, including the specification, drawings, and claims, is incorporated by reference herein in its entirety.

### BACKGROUND

### 1. Technical Field

The present disclosure relates to batteries.

### 2. Description of Related Art

Battery development has been active in recent years. For example, in the automotive industry, batteries for use in battery electric vehicles (BEVs), plug-in hybrid electric vehicles (PHEVs), and hybrid electric vehicles (HEVs) have been actively developed.

The use of fluoroethylene carbonate (FEC) as a component of the electrolytic solution in batteries has been studied. For example, WO2012/102259 discloses a non-aqueous electrolyte secondary battery in which 0.5 parts by weight or more of fluoroethylene carbonate is added to 100 parts by weight of a non-aqueous electrolytic solution. Japanese Unexamined Patent Application Publication No. 2019-169700 (JP 2019-169700 A) discloses an electrolytic solution for an electrochemical device to which fluoroethylene carbonate is added.

### SUMMARY

Fluoroethylene carbonate (FEC) is expected to serve as an electrolytic solution component (solvent component) that can improve battery characteristics such as cycle characteristics. In this regard, when the amount of FEC is large, the cycle characteristics can be improved, but there is a risk that gas derived from FEC may be generated. On the other hand, when the amount of FEC is small, such gas generation is reduced, but good cycle characteristics may not be obtained.

The present disclosure has been made in view of the above circumstances, and a primary object of the present disclosure is to provide a battery in which gas generation derived from FEC is reduced and that exhibits good cycle characteristics.

(1) A battery includes a bipolar electrode. The bipolar electrode includes an intermediate current collector, a cathode composite layer disposed on a first surface of the intermediate current collector, and an anode composite layer disposed on a second surface of the intermediate current collector. The battery includes a plurality of cells arranged in a thickness direction. Each of the cells includes an electrode assembly that includes the cathode composite layer, a separator layer, and the anode composite layer. Each of the cells independently contains an electrolytic solution containing fluoroethylene carbonate (FEC) as a solvent component. When the cell located at an end in the thickness direction among the cells is defined as an end cell, and the cell located inward of the end cell among the cells is defined as an internal cell, the proportion of FEC in the solvent component of the internal cell is greater than the proportion of FEC in the solvent component of the end cell.

(2) In the battery according to (1), when the cell located at the center in the thickness direction among the internal cells is defined as a central cell, and the cell located outward of the central cell in the thickness direction among the internal cells is defined as an outer cell, the proportion of FEC in the central cell is greater than the proportion of FEC in the end cell, and the proportion of FEC in the outer cell is smaller than the proportion of FEC in the central cell.

(3) In the battery according to (2), the proportion of FEC in the outer cell is smaller than the proportion of FEC in the end cell.

(4) In the battery according to (2) or (3), when X represents the proportion of FEC in the end cell and Y represents the proportion of FEC in the central cell, the ratio of Y to X (Y/X) is greater than or equal to 1.05 and less than or equal to 3.50.

(5) In the battery according to any one of (1) to (4), the number of the internal cells is greater than or equal to three and less than or equal to 100.

The present disclosure can provide a battery in which gas generation derived from FEC is reduced and that exhibits good cycle characteristics.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic cross-sectional view illustrating a bipolar electrode according to the present disclosure;

FIG. 1B is a schematic cross-sectional view illustrating a cell according to the present disclosure;

FIG. 1C is a schematic cross-sectional view illustrating a battery according to the present disclosure;

FIG. 2A is a schematic diagram illustrating an internal cell in the present disclosure;

FIG. 2B is a schematic diagram illustrating internal cells in the present disclosure;

FIG. 2C is a schematic diagram illustrating internal cells in the present disclosure;

FIG. 2D is a schematic diagram illustrating internal cells in the present disclosure;

FIG. 3A is a schematic diagram illustrating internal cells in the present disclosure;

FIG. 3B is a schematic diagram illustrating internal cells in the present disclosure;

FIG. 4 is a schematic diagram illustrating internal cells in the present disclosure;

FIG. 5A is a schematic diagram illustrating batteries fabricated in Examples and Comparative Examples;

FIG. 5B is a schematic diagram illustrating batteries fabricated in Examples and Comparative Examples; and

FIG. 5C is a schematic diagram illustrating batteries fabricated in Examples and Comparative Examples.

### DETAILED DESCRIPTION OF EMBODIMENTS

Hereinafter, a battery according to the present disclosure will be described in detail. The drawings shown below are schematic illustrations, and the sizes and shapes of the components are exaggerated as appropriate to facilitate understanding. In the present specification, when the term “above” or “below” is merely used to describe the arrangement of one member with respect to another member, this includes both a case in which the one member is disposed directly above or directly below the other member in such a manner that the one member is in contact with the other member, and a case in which the one member is disposed above or below the other member with still another member interposed therebetween, unless specified otherwise.

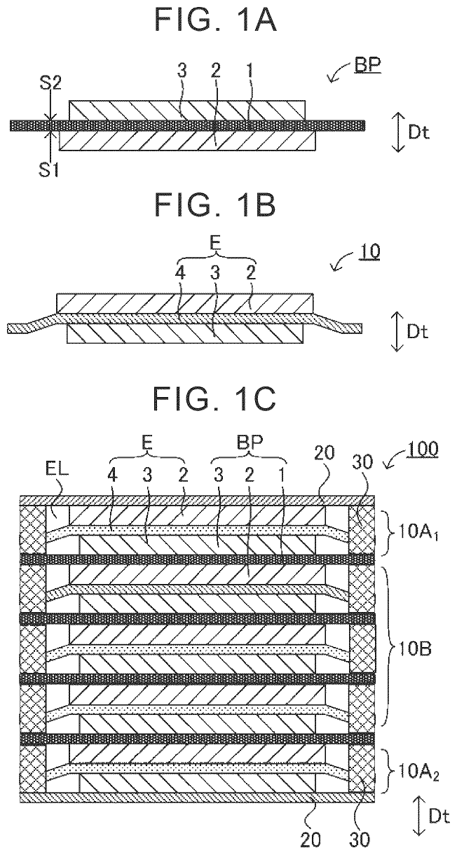

FIGS. 1A, 1B, and 1C are schematic cross-sectional views respectively illustrating a bipolar electrode, a cell, and a batterie according to the present disclosure. FIG. 1A is a schematic cross-sectional view illustrating a bipolar electrode, FIG. 1B is a schematic cross-sectional view illustrating a cell, and FIG. 1C is a schematic cross-sectional view illustrating a battery.

As shown in FIGS. 1A and 1C, a battery 100 of the present disclosure includes a bipolar electrode BP. The bipolar electrode BP includes an intermediate current collector 1, a cathode composite layer 2 disposed on a first surface S1 of the intermediate current collector 1, and an anode composite layer 3 disposed on a second surface S2 of the intermediate current collector 1. As shown in FIGS. 1B and 1C, the battery 100 includes a plurality of cells 10 (10A, 10B) arranged in a thickness direction Dt. Each of the cells 10 includes an electrode assembly E that includes a cathode composite layer 2, a separator layer 4, and an anode composite layer 3. As shown in FIG. 1C, in each of the cells 10, the internal space is isolated from the other cells by current collectors (intermediate current collector 1 and terminal current collector 20) and a sealing member 30, and the internal space is filled with an electrolytic solution EL.

As shown in FIG. 1C, each of the cells 10 independently contains the electrolytic solution EL that contains fluoroethylene carbonate (FEC) as a solvent component. When the cells located at the ends in the thickness direction Dt among the cells 10 are defined as end cells 10A (10A₁, 10A₂), and any cell located inward of the end cells 10A among the cells 10 are defined as an internal cell 10B, the proportion of FEC in the solvent component in the internal cell 10B is greater than the proportion of FEC in the solvent component in the end cells 10A.

In the present disclosure, when the battery includes a plurality of internal cells, it is sufficient that the proportion of FEC in at least one of the internal cells is greater than the proportion of FEC in the end cells. The proportion of FEC in all of the internal cells may be greater than the proportion of FEC in the end cells.

According to the present disclosure, since the proportion of FEC in the solvent component in the internal cell is greater than the proportion of FEC in the solvent component in the end cells, it is possible to obtain a battery in which gas generation derived from FEC is reduced and that exhibits good cycle characteristics.

As described above, increasing the proportion of FEC (the proportion of FEC in the solvent component) to achieve good cycle characteristics results in an increased amount of gas generation. An increased amount of gas generation may accelerate degradation of a battery casing. In addition, there is a risk that charge and discharge reactions may become uneven, which may facilitate localized deposition of Li and increase the possibility of short circuits. On the other hand, reducing the proportion of FEC to reduce gas generation may result in depletion of FEC after repeated cycles, which may lead to deterioration in cycle characteristics. In this regard, the inventors focused on the fact that, in a battery including a plurality of cells, some cells undergo more active charging and discharging while others undergo less active charging and discharging, and conceived the idea of adjusting the proportion of FEC for each cell. Specifically, in inner cells (internal cells), heat is less likely to be dissipated, and the temperature tends to increase. Therefore, the internal cells undergo more active charging and discharging compared to the outermost cells (end cells). Based on this, the inventors conceived the idea of increasing the proportion of FEC in the internal cells compared to the end cells, that is, increasing the amount of FEC in the cells that undergo more active charging and discharging, and reducing the proportion of FEC in the cells that undergo less active charging and discharging. Adjusting the proportion of FEC in this manner can reduce the overall proportion of FEC in the battery and thus reduces gas generation, compared to a case where the proportion of FEC is uniformly set based on the cells that undergo more active charging and discharging (the cells that need a large amount of FEC). Adjusting the proportion of FEC in this manner can also reduce the occurrence of cells with deteriorated cycle characteristics and achieve better overall cycle characteristics of the battery, compared to a case where the proportion of FEC is uniformly set based on the cells that undergo less active charging and discharging (the cells that do not need a large amount of FEC).

### A. Battery Configuration

The battery of the present disclosure includes, as the cells, end cells and at least one internal cell. The cell configuration is as described above.

### 1. End Cells

In the present disclosure, the end cells refer to the cells located at the ends in the thickness direction. As shown in FIG. 1C, each of the end cells 10A (10A₁, 10A₂) includes an intermediate current collector 1 and a terminal current collector 20. Each end cell 10A shares the intermediate current collector 1 with its adjacent internal cell 10B. A sealing member 30 is disposed on the outer periphery of the end cell 10A, thereby sealing the space between the intermediate current collector 1 and the terminal current collector 20.

The number of end cells is typically two. The two end cells may have the same proportion of FEC or different proportions of FEC. As used herein, the concept expressed by “having the same proportion of FEC” includes not only a case where the two cells have exactly the same proportion of FEC, but also cases where the difference between the two cells is within ±0.1 vol %.

### 2. Internal Cell

In the present disclosure, the internal cell refers to any cell located inward of the end cells (that is, located on the inner side of the battery in the thickness direction). As shown in FIG. 1C, two internal cells 10B that are adjacent in the thickness direction Dt share an intermediate current collector 1. A sealing member 30 is disposed on the outer periphery of each of the internal cells 10B, thereby sealing the space between the opposing intermediate current collectors 1.

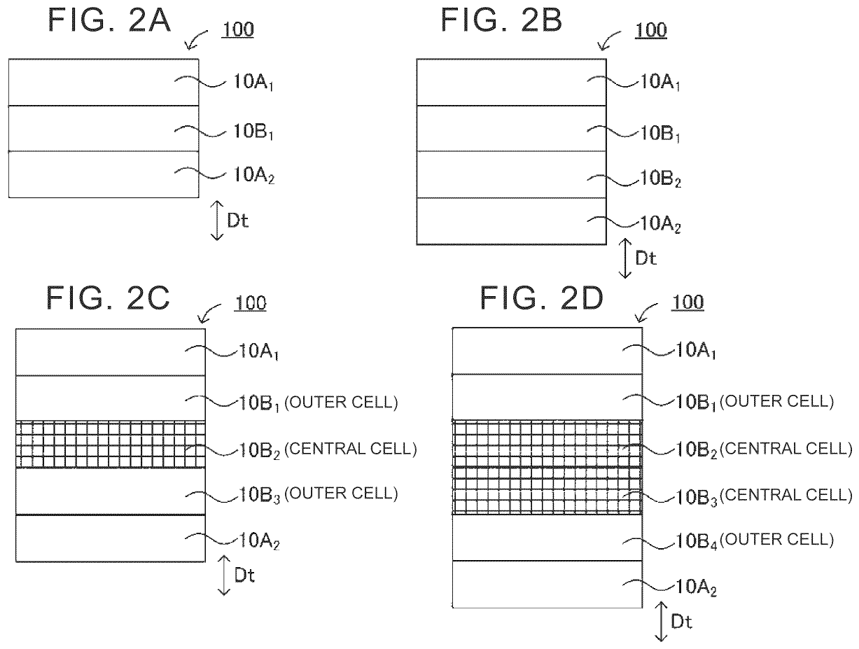

The number of internal cells is not particularly limited. As shown in FIGS. 2A and 2B, the number of internal cells 10B may be one or two. Alternatively, as shown in FIGS. 2C and 2D, the number of internal cells 10B may be three or more. The number of internal cells is, for example, 100 or less, and may be 80 or less, or may be 50 or less. As will be described later, when the number of internal cells is three or more, the internal cells can be broadly classified into a central cell and outer cells.

### (1) Central Cell

The central cell refers to the cell located at the center in the thickness direction among the internal cells. As shown in FIG. 2C, when the number of internal cells 10B is an odd number (e.g., three), the number of central cells is one (internal cell 10B₂). On the other hand, as shown in FIG. 2D, when the number of internal cells 10B is an even number (e.g., four), the number of central cells is two (internal cells 10B₂, 10B₃).

When the number of internal cells is N (where N is an odd number greater than or equal to 3), the position of the central cell can be identified as follows. When the internal cells are numbered from the first to the Nth starting from one end in the thickness direction, and the central cell is the Xth internal cell, the value of X can be determined as the number that satisfies 2X=N+1.

When the number of internal cells is M (where M is an even number greater than or equal to 4), the positions of the central cells can be identified as follows. When the internal cells are numbered from the first to the Mth starting from one end in the thickness direction, and the central cells are the Xth and (X+1)th internal cells, the value of X can be determined as the number that satisfies 2X=M.

It is preferable that the proportion of FEC in the central cell be higher than the proportion of FEC in the end cells. This is because the central cell located at the center of the battery tends to undergo the largest temperature increase among the internal cells, which results in more active electrochemical reactions. When X represents the proportion of FEC in the end cells and Y represents the proportion of FEC in the central cell, the ratio of Y to X (Y/X) is, for example, 1.05 or more, and may be 1.10 or more, 1.30 or more, 1.50 or more, or 1.80 or more. The ratio Y/X is, for example, 3.50 or less, and may be 3.00 or less, 2.50 or less, or 2.00 or less.

The proportion of FEC in the central cell is not particularly limited as long as it satisfies the above relationship, but is, for example, greater than or equal to 2.5 vol % and less than or equal to 4.0 vol %. When the number of central cells is two (the number of internal cells is an even number), the two central cells may have the same proportion of FEC or different proportions of FEC. The expression “having the same proportion of FEC” is as described above. The electrolytic solution components other than FEC will be described in “B. Battery Components.”

### (2) Outer Cells

The outer cells refer to the cells located outward of the central cell in the thickness direction (that is, located on the outer sides of the battery in the thickness direction) among the internal cells. The number of outer cells is, for example, two or more, and may be four or more, or six or more. The number of outer cells is, for example, 98 or less.

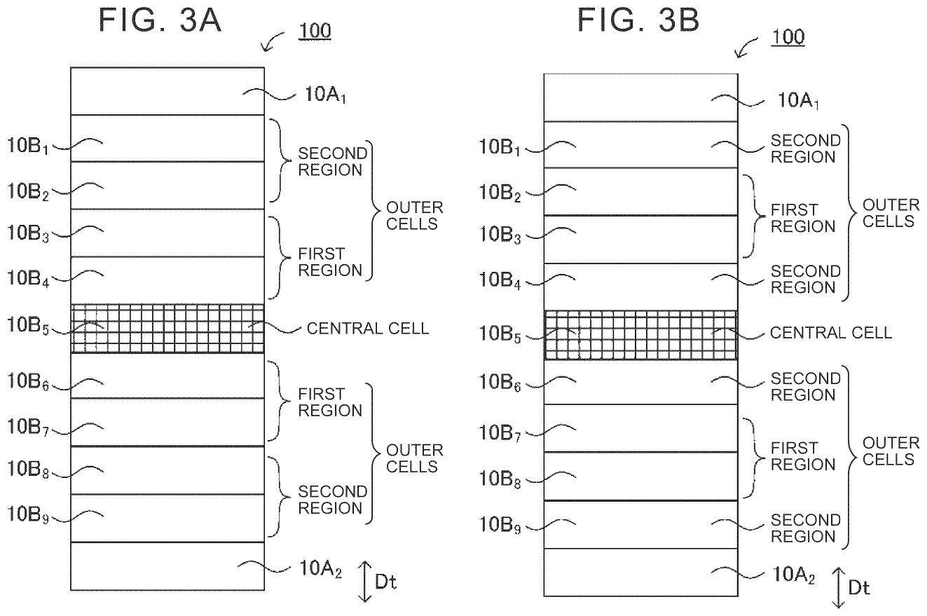

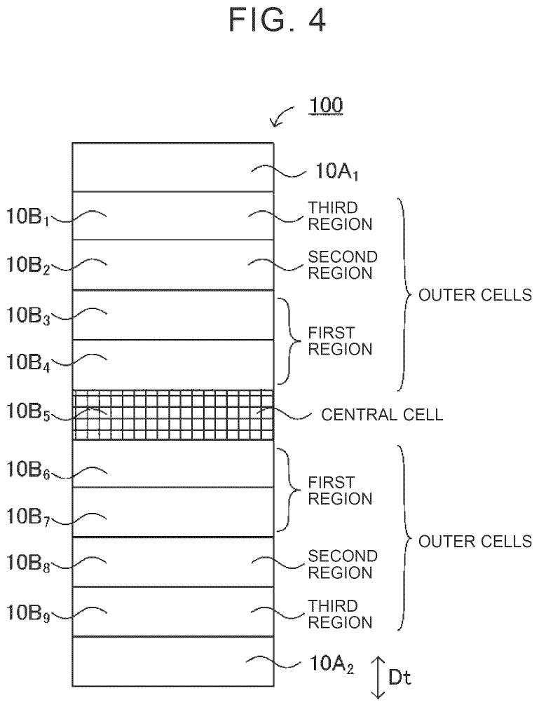

Although the outer cells are disposed on both sides of the central cell in the thickness direction, the following description focuses on the outer cells disposed on one side of the central cell (for example, internal cells 10B₁ to 10B₄ in FIGS. 3A, 3B, and 4). This description can also be applied as appropriate to the outer cells disposed on the other side of the central cell (for example, internal cells 10B₆ to 10B₉ in FIGS. 3A, 3B, and 4). For example, as shown in FIGS. 3A, 3B, and 4, the configuration of the outer cells (the region and the proportion of FEC) may be the same (symmetrical) on both sides of the central cell. Although not shown in the figures, the configuration of the outer cells may be different between the two sides of the central cell.

It is preferable that the proportion of FEC in the outer cells be smaller than the proportion of FEC in the central cell. This is because the outer cells are located closer to the end of the battery than the central cell, and are therefore considered less likely to experience a temperature increase and to undergo active charging and discharging, compared to the central cell. When there is a plurality of outer cells, it is sufficient that the proportion of FEC in at least one of the outer cells is smaller than the proportion of FEC in the central cell.

It is preferable that the proportion of FEC in the outer cells be smaller than the proportion of FEC in the end cell. In other words, in the battery, it is preferable that the proportions of FEC satisfy the following relationship: central cell>end cell>outer cell. This is because a current collecting tab (also referred to as “tab”) may be attached to the terminal current collector of the end cell, which reduces the battery resistance compared to the outer cells. The end cell is therefore considered to undergo more active charging and discharging than the outer cells. As described above, it is sufficient that at least one outer cell satisfies the above relationship. Additionally, the proportion of FEC in the outer cells may be the same as the proportion of FEC in the end cell, or may be greater than the proportion of FEC in the end cell. As described above, it is sufficient that at least one outer cell satisfies the above relationship.

The outer cells can be classified into first to third regions, which will be described below, based on the proportion of FEC. The outer cells may have one of the first to third regions, may have any two of them, or may have all three of them.

### (i) First Region

The first region is a region constituted by outer cells having the same proportion of FEC as that of the central cell. The expression “having the same proportion of FEC” is as described above.

As shown in FIG. 3A, the first region may be adjacent to the central cell. Alternatively, as shown in FIG. 3B, the first region may not be adjacent to the central cell. As shown in FIGS. 3A and 3B, when the outer cells have the first and second regions, it is preferred that the first region not be adjacent to the end cell 10A₁.

The number of outer cells constituting the first region is not particularly limited, but is, for example, greater than or equal to one and less than or equal to 40. When the outer cells further have either or both of the second region and the third region, the first region may be present at one location on one side of the central cell (FIGS. 3A, 3B, and 4), or may be present at two or more separated locations (not shown). When there is a plurality of first regions, it is preferable that at least one of the first regions be adjacent to the central cell.

### (ii) Second Region

The second region is a region constituted by outer cells having a proportion of FEC different from that of both the central cell and the end cell. It is preferable that the proportion of FEC in the outer cells constituting the second region be smaller than the proportion of FEC in the end cell. It is also preferable that the proportion of FEC in the outer cells constituting the second region be smaller than the proportion of FEC in the central cell. When a plurality of outer cells constitutes the second region, these outer cells may have the same proportion of FEC, or may have different proportions of FEC. In the latter case, the proportion of FEC may increase towards the central cell. For example, in the battery 100 shown in FIG. 3A, the proportions of FEC may satisfy the following relationship: internal cell (outer cell) 10B₁<internal cell (outer cell) 10B₂.

The number of outer cells constituting the second region is not particularly limited, but is, for example, greater than or equal to one and less than or equal to 40. Like the first region, the second region may be present at one location on one side of the central cell (FIG. 3A), or may be present at two or more separated locations (FIG. 3B).

(iii) Third Region

The third region is a region constituted by outer cells having the same proportion of FEC as that of the end cell. As shown in FIG. 4, it is preferable that the third region be adjacent to the end cell 10A₁. The number of outer cells constituting the third region is not particularly limited, but is, for example, greater than or equal to one and less than or equal to 10. Like the first region, the third region may be present at one location on one side of the central cell (FIG. 4), or may be present at two or more separated locations (not shown).

### (iv) Outer Cells

When Z represents the average value of the proportions of FEC in the outer cells, Z may be the same as the proportion X of FEC in the end cell, or may be higher or lower than the proportion X. The ratio of Z to X (Z/X) is, for example, greater than or equal to 0.30 and less than or equal to 1.20.

### (3) Internal Cells

When Q represents the average value of the proportions of FEC in the internal cells, Q may be the same as the proportion X of FEC in the end cell, or may be higher or lower than the proportion X. The ratio of Q to X (Q/X) is, for example, greater than or equal to 0.40 and less than or equal to 1.40.

### B. Battery Components

### 1. Cathode Composite Layer

The cathode composite layer contains at least a cathode active material. The cathode composite layer may further contain either or both of a binder and an electrically conductive material. The cathode composite layer is typically impregnated with an electrolytic solution that will be described later.

Examples of the cathode active material include oxide active materials. Examples of oxide active materials include layered rock-salt type active materials such as LiNi_{1/3}Co_{1/3}Mn_{1/3}O₂, spinel-type active materials such as LiMn₂O₄, and olivine-type active materials such as LiFePO₄. Sulfur(S) may be used as the cathode active material. The cathode active material is, for example, in the form of particles.

Examples of the electrically conductive material include carbon materials. Examples of the binder include rubber-based binders and fluoride-based binders.

### 2. Anode Composite Layer

The anode composite layer contains at least an anode active material. The anode composite layer may further contain either or both of an electrically conductive material and a binder. Examples of the anode active material include metal active materials such as Li and Si, carbon active materials such as graphite, and oxide active materials such as Li₄Ti₅O₁₂. The anode active material is, for example, in the form of particles or foil. The electrically conductive material, the electrolytic solution, and the binder are the same as those described in “1. Cathode Composite Layer.”

### 3. Separator Layer

The separator layer is a layer of a porous material impregnated with an electrolytic solution that will be described later. The material (porous material) of the separator layer may be an organic material or an inorganic material. Specific examples include porous membranes made of polyethylene (PE), polypropylene (PP), cellulose, polyvinylidene fluoride, polyamide, and polyimide, nonwoven fabrics such as resin nonwoven fabrics and glass fiber nonwoven fabrics, and ceramic porous membranes. The separator layer may have a single-layer structure or a multilayer structure.

### 4. Electrolytic Solution

The electrolytic solution contains a supporting salt and a solvent. The electrolytic solution according to the present disclosure contains at least FEC as a solvent component. The proportion of FEC is the same as that described in “A. Battery Configuration.”

The supporting salt may be any known supporting salt used in lithium-ion batteries. Examples of the supporting salt include lithium salts such as LiPF₆. The solvent may be any known solvent used in lithium-ion batteries. Examples of the solvent include carbonate-based solvents such as ethylene carbonate (EC), propylene carbonate (PC), butylene carbonate (BC), ethyl methyl carbonate (EMC), and dimethyl carbonate (DMC). The electrolytic solution may contain one solvent or two or more solvents as solvent components other than FEC.

### 5. Intermediate Current Collector

The intermediate current collector is not particularly limited as long as it is a member that can serve as a cathode current collector and an anode current collector. The cathode current collector and the anode current collector will be described later. The intermediate current collector may be a member made of a single metal foil. Alternatively, the intermediate current collector may be a member in which two (two types of) metal foils (a cathode current collector and an anode current collector) are laminated together.

### 6. Terminal Current Collector

As shown in FIG. 1C, the terminal current collectors 20 are current collectors arranged at both ends in the thickness direction Dt. Typically, one of them is a cathode current collector and the other is an anode current collector. Examples of the material of the cathode current collector include metals such as aluminum, steel use stainless (SUS), and nickel. Examples of the material of the anode current collector include metals such as copper, SUS, and nickel.

### 7. Other Components

The sealing member is, for example, a member made of resin. Examples of the resin include thermoplastic resins such as polyvinylidene fluoride (PVdF). The battery may include a casing that seals the components described above. The casing may be, for example, a laminate film.

### 8. Battery

The battery according to the present disclosure is typically a lithium-ion secondary battery. Examples of applications of the battery include power sources for vehicles such as hybrid electric vehicles (HEVs), plug-in hybrid electric vehicles (PHEVs), battery electric vehicles (BEVs), gasoline vehicles, and diesel vehicles. In particular, the battery is preferably used as a traction power source for a hybrid electric vehicle (HEV), a plug-in hybrid electric vehicle (PHEV), or a battery electric vehicle (BEV). The battery according to the present disclosure may be used as a power source for moving objects other than vehicles (e.g., trains, ships, and aircraft), or may be used as a power source for electric devices such as information processing devices.

The present disclosure is not limited to the above embodiment. The above embodiment is merely illustrative, and any structure having substantially the same configuration as, and having similar functions and effects to, the technical idea described in the claims of the present disclosure is included in the technical scope of the present disclosure.

### Example 1

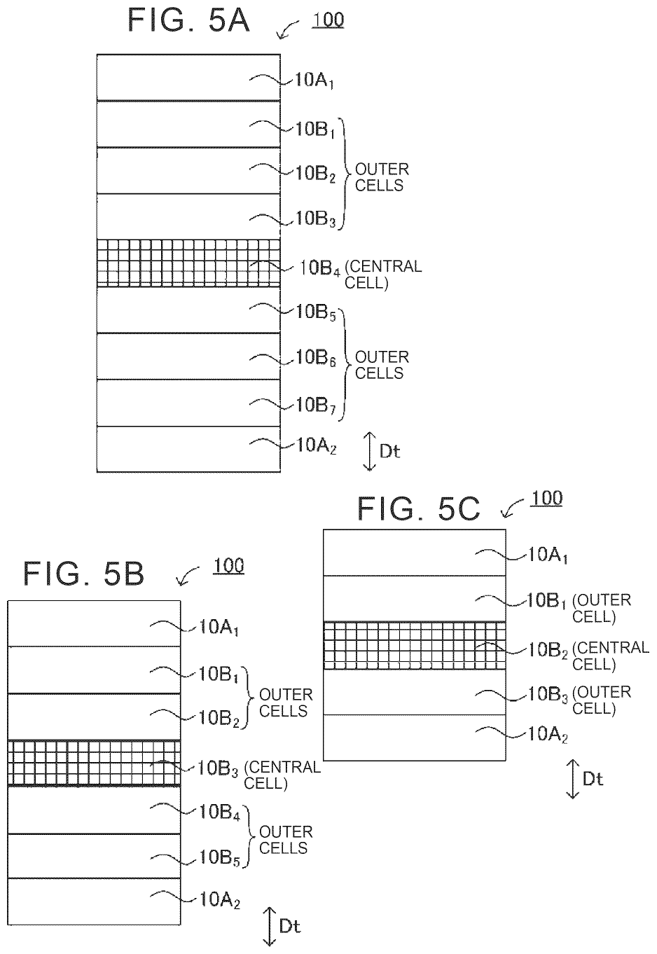

A battery having a layer structure as shown in FIG. 5A was fabricated as follows.

### Fabrication of Cathode

A cathode paste was prepared by kneading a cathode active material (average particle size: 10 μm, LiNi_{0.8}Co_{0.1}Mn_{0.1}O₂), an electrically conductive material (granular acetylene black), and a binder (polyvinylidene fluoride (PVdF)) in a ratio of 93:4:3 with a solvent (N-methyl-2-pyrrolidone (NMP)). The solid content of the paste was adjusted to 65% using NMP. The cathode paste was applied to an aluminum foil with a thickness of 30 μm and dried to prepare a coated electrode. The coating amount was adjusted such that the basis weight on one side after drying would be 20 mg/cm². The coated electrode was then pressed using a roll press machine. The composite density after pressing was 2.7 g/cc. The pressed electrode was cut into 12 cm×12 cm pieces, and the composite was peeled off from 1 cm-wide regions along the outer edges to expose the aluminum foil. A cathode having a cathode composite layer on one side of the aluminum foil was thus obtained.

### Fabrication of Anode

An anode paste was prepared by mixing 77 parts by weight of spheroidized natural graphite (average diameter: 17 μm), 19 parts by weight of silicon monoxide (average particle size: 6 μm), 0.5 parts by weight of carboxymethyl cellulose, 2 parts by weight of styrene-butadiene rubber, 1.2 parts by weight of lithium polyacrylate, 0.3 parts by weight of carbon nanotubes, and 85 parts by weight of deionized water, and kneading the mixture for 20 minutes using a planetary mixer. The anode paste was applied to a copper foil with a thickness of 15 μm and dried to prepare a coated electrode. The coating amount was adjusted such that the basis weight on one side after drying would be 6.4 mg/cm². The coated electrode was then pressed using a roll press machine. The composite density after pressing was 1.2 g/cc. The pressed electrode was cut into 12 cm×12 cm pieces, and the composite was peeled off from 0.7 cm-wide regions along the outer edges to expose the copper foil. An anode having an anode composite layer on one side of the copper foil was thus obtained.

### Fabrication of Bipolar Electrode

A bonding paste was prepared by kneading 10 parts by weight of acetylene black, five parts by weight of PVdF, and 15 parts by weight of NMP. The paste was applied to the surface of the aluminum foil of the cathode on which no cathode composite layer was formed, and to the surface of the copper foil of the anode on which no anode composite layer was formed. The cathode and the anode were then bonded together. The resultant bonded electrode was placed in a drying oven and dried at 120° C. for 30 minutes. A bipolar electrode was thus fabricated.

### Fabrication of Battery

Two bipolar electrodes were laminated with a separator layer (porous polyethylene; thickness: 20 μm, dimensions: 11.5 cm×11.5 cm) therebetween such that the cathode composite layer and the anode composite layer faced each other. A sealing paste containing seven parts by weight of PVdF and 93 parts by weight of NMP was applied to the exposed regions of the copper foil along the four sides of the anode. During lamination, the copper foil and aluminum foil were bonded together via the sealing paste. The resultant laminate was placed in a drying oven and dried at 120° C. for 30 minutes to solidify the sealing paste. An unbonded region of about 1 cm was provided in the middle of one of the four sides of the laminate to serve as an electrolyte filling port. This process was repeated to fabricate a stack in which nine cells 10, each including an electrode assembly that includes the cathode composite layer, the separator layer, and the anode composite layer, were stacked as shown in FIG. 5A. The cathode was placed on one end of the laminate, and the anode was placed on the other end of the laminate.

Thereafter, 1.5 mL of the electrolytic solution was injected into each cell through the electrolyte filling port using a micropipette. After injection, reduced-pressure impregnation was carried out in a vacuum furnace for three minutes to allow sufficient impregnation of the electrodes with the electrolytic solution. Subsequently, the same sealing paste as described above was injected into a sealing port, and a drying process was performed at 120° C. for 30 minutes to seal the electrolyte filling port. As shown in Table 1 below and FIG. 5A, an electrolytic solution A having an FEC content of 3.2 vol % was injected into the central cell (internal cell 10B₄), an electrolytic solution B having an FEC content of 2.7 vol % was injected into the end cells (10A₁, 10A₂), and an electrolytic solution C having an FEC content of 2.7 vol % was injected into the outer cells (internal cells 10B₁ to 10B₃, 10B₅ to 10B₇). A cathode tab (aluminum tab) was ultrasonically welded to the terminal current collector of one of the end cells, and an anode tab (copper tab) was ultrasonically welded to the terminal current collector of the other end cell. The compositions of the electrolytic solutions are as follows.

### Electrolytic Solution A

### Solvent:

EC:FEC:EMC:DMC=0.268:0.032:0.3:0.4 (volume ratio)

### Supporting Salt:

LIPF₆: 1 mol/kg

### Electrolytic Solution B

### Solvent:

EC:FEC:EMC:DMC=0.273:0.027:0.3:0.4 (volume ratio)

### Supporting Salt:

LIPF₆: 1 mol/kg

### Electrolytic Solution C

### Solvent:

EC:FEC:EMC:DMC=0.29:0.001:0.3:0.4 (volume ratio)

### Supporting Salt:

LIPF₆: 1 mol/kg

### Examples 2 to 4 and Comparative Examples 1 to 4

As shown in Table 1 and FIGS. 5A, 5B, and 5C, batteries were fabricated in the same manner as in Example 1, except that either or both of the number of stacked cells in the battery and the proportion of FEC in the electrolytic solution in each cell was changed. The electrolytic solutions A to C described above were used as the electrolyte solutions. FIG. 5B is a schematic diagram of a battery having seven stacked cells (Example 2 and Comparative Example 3), and FIG. 5C is a schematic diagram of a battery having five stacked cells (Example 3 and Comparative Example 4).

### Evaluation

### Cycle Test

A charge and discharge test (cycle test) was performed under the following conditions. The cycle test was conducted at 25° C.

### Initial Charge and Discharge

Charging: 4.2 V×number of stacked electrode assemblies, CCCV, cut-off current: 3 mA, current: 60 mA

Discharging: 2.5 V×number of stacked electrode assemblies, CCCV, cut-off current: 3 mA, current: 60 mA

### Cycle Test

Charging: 4.2 V×number of stacked electrode assemblies, CCCV, cut-off current: 15 mA, current: 300 mA

Discharging: 2.5 V×number of stacked electrode assemblies, CCCV, cut-off current: 15 mA, current: 300 mA

The ratio of the discharge capacity at the 20th cycle to the initial discharge capacity was calculated as the capacity retention rate. The results are shown in Table 1. In the cycle test, when the amount of decrease in discharge capacity between the (N−1)th and Nth cycles became three times or more the amount of decrease in discharge capacity between the (N−2)th and (N−1)th cycles, it was determined that rapid degradation had occurred in the Nth cycle. The number of cycles (N) until the occurrence of rapid degradation was compared. The results are shown in Table 1. When rapid degradation occurs, it is presumed that a cell in which FEC has been depleted is generated. Therefore, the larger the number of cycles N, the less likely FEC-depleted cells are to be generated. This means that the battery can be stably charged and discharged for a longer period.

### Storage Test

The fabricated battery was initially charged to a fully charged state under the above conditions. The battery was then left so stand in a thermostatic chamber at 60° C., and the amount of gas generated due to side reactions inside the battery was measured. The results are shown in Table 1. The amount of gas generated was measured by the Archimedes method. The difference in battery volume before and after 100 days of storage in the thermostatic chamber was obtained as the amount of gas generated.

TABLE 1

| | | | | | | | | Cycle Test | |
|---|---|---|---|---|---|---|---|---|---|
| | Number | FEC Content (vol %) | | | | | Storage Test | | Cycle at |
| | of | Central | End | | | | Amount of Gas | Capacity | Which Rapid |
| | Stacked | Cell | Cells | Outer | | | Generated | Retention | Degradation |
| | Cells | (Y) | (X) | Cells | Average | Y/X | (cc) | Rate (%) | Occurred (N) |
| Example 1 | 9 | 3.2 | 2.7 | 1.0 | 1.62 | 1.19 | 9 | 96 | 686 |
| Example 2 | 7 | 3.2 | 2.7 | 1.0 | 1.80 | 1.19 | 6 | 96 | 711 |
| Example 3 | 5 | 3.2 | 2.7 | 1.0 | 2.12 | 1.19 | 4 | 96 | 700 |
| Example 4 | 9 | 3.2 | 1.0 | 1.0 | 1.24 | 3.20 | 7 | 96 | 641 |
| Comparative | 9 | 3.2 | 3.2 | 3.2 | 3.20 | 1.00 | 28 | 88 | 656 |
| Example 1 | | | | | | | | | |
| Comparative | 9 | 1.0 | 1.0 | 1.0 | 1.00 | 1.00 | 7 | 96 | 254 |
| Example 2 | | | | | | | | | |
| Comparative | 7 | 3.2 | 3.2 | 3.2 | 3.20 | 1.00 | 22 | 90 | 644 |
| Example 3 | | | | | | | | | |
| Comparative | 5 | 3.2 | 3.2 | 3.2 | 3.20 | 1.00 | 15 | 96 | 611 |
| Example 4 | | | | | | | | | |

As shown in Examples 1 to 4 and Comparative Examples 1 to 4, it was demonstrated that, by adjusting the proportion of FEC in each cell, specifically by providing at least one internal cell in which the proportion of FEC is higher than that in the end cells, it is possible to obtain a battery in which gas generation derived from FEC is reduced and that exhibits good cycle characteristics. For example, as shown in Comparative Example 1, when the proportion of FEC was uniformly set based on the cell that underwent more active charging and discharging (the central cell), the cycle characteristics (capacity retention rate at the 20th cycle and the number of cycles N) were good, but the amount of gas generated was significantly greater than in the Examples. As shown in Comparative Example 2, when the proportion of FEC was uniformly set based on the cell that underwent less active charging and discharging (the end cells), the amount of gas generated was reduced, but the number of cycles N was small, and the cycle characteristics were inferior to those of the Examples. Based on the results of Examples 3 and 4, it was confirmed that the cycle characteristics (the number of cycles N) can be improved by setting the proportion of FEC in the end cells higher than that in the outer cells (that is, by making the proportion of FEC in at least one outer cell lower than that in the end cells). This is considered to be because the end cells had lower cell resistance than the outer cells and underwent more active charging and discharging.

What is claimed is:

1. A battery including a bipolar electrode, the bipolar electrode including an intermediate current collector, a cathode composite layer disposed on a first surface of the intermediate current collector, and an anode composite layer disposed on a second surface of the intermediate current collector, the battery comprising a plurality of cells arranged in a thickness direction, each of the cells including an electrode assembly that includes the cathode composite layer, a separator layer, and the anode composite layer, wherein:
each of the cells independently contains an electrolytic solution containing fluoroethylene carbonate as a solvent component; and
when the cell located at an end in the thickness direction among the cells is defined as an end cell, and the cell located inward of the end cell among the cells is defined as an internal cell,
a proportion of the fluoroethylene carbonate in the solvent component of the internal cell is greater than a proportion of the fluoroethylene carbonate in the solvent component of the end cell.

2. The battery according to claim 1, wherein, when the cell located at a center in the thickness direction among the internal cells is defined as a central cell, and the cell located outward of the central cell in the thickness direction among the internal cells is defined as an outer cell,
a proportion of the fluoroethylene carbonate in the central cell is greater than the proportion of the fluoroethylene carbonate in the end cell, and
a proportion of the fluoroethylene carbonate in the outer cell is smaller than the proportion of the fluoroethylene carbonate in the central cell.

3. The battery according to claim 2, wherein the proportion of the fluoroethylene carbonate in the outer cell is smaller than the proportion of the fluoroethylene carbonate in the end cell.

4. The battery according to claim 2, wherein, when X represents the proportion of the fluoroethylene carbonate in the end cell and Y represents the proportion of the fluoroethylene carbonate in the central cell, a ratio of Y to X is greater than or equal to 1.05 and less than or equal to 3.50.

5. The battery according to claim 1, wherein the number of the internal cells is greater than or equal to three and less than or equal to 100.
